(19) United States
(12) Patent Application Publication
(10) Pub. No.: US 2025/0334792 A1
(43) Pub. Date: Oct. 30, 2025

(54) OPTICAL WEDGE IN FMCW LIDAR OPTICS SYSTEM

(71) Applicant: AEVA, INC., Mountain View, CA (US)

(72) Inventors: Shijun Xiao, Foster City, CA (US); Daniel Gene Smith, Tucson, AZ (US)

(21) Appl. No.: 18/649,285

(22) Filed: Apr. 29, 2024

(51) Int. Cl. G02B 26/08; G01S 7/481; G02B 26/10

(52) U.S. Cl. CPC G02B 26/0891; G01S 7/4817; G02B 26/10

(57) ABSTRACT

A LiDAR system that includes an optical wedge is disclosed herein. The LiDAR system transmits, along a Tx chief ray axis, a Tx beam that, in either order, passes through a source lens and contacts a surface of the optical wedge. The source lens is centered about the Tx chief ray axis. The optical wedge directs the Tx beam at a first angle relative to the Tx chief ray axis. The optical wedge refracts a BPLO beam at a second angle relative to the Tx chief ray axis. The second angle is different from the first angle. A system lens receives the Tx beam and the BPLO beam according to a symmetric beam footprint on the system lens.

### FIELD

The present disclosure is related to light detection and ranging (LiDAR) systems in general. One aspect of the present disclosure relates to an optical wedge in a frequency modulated continuous wave (FMCW) LiDAR optics system.

### BACKGROUND

FMCW LiDAR systems experience a time delay lag caused by a time-of-flight for light to be propagated between a LiDAR unit and a target. The time delay causes a beam walkoff between a local oscillator (LO) beam and a receive (Rx) beam at a mechanical mirror scanning for coherent LiDAR signals. The LO and Rx beams are mixed or coupled to generate an optical mixing heterodyne signal through a photo detector, which is also referred to as heterodyne detection. The detection converts the Rx optical signal to an electrical signal for a processing procedure that computes a range and velocity for each point in a point cloud or LiDAR image. Optical mixing can be modeled based on coupling between a back projected LO (BPLO) beam and a transmit (Tx) beam, such that the beam walkoff between the LO beam and the Rx beam can be correlated with the beam walkoff between the BPLO and the Tx beams.

### SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A LiDAR system that includes an optical wedge is disclosed herein. The LiDAR system transmits, along a Tx chief ray axis, a Tx beam that, in either order, passes through a source lens and contacts a surface of the optical wedge. The source lens is centered about the Tx chief ray axis. The optical wedge directs the Tx beam at a first angle relative to the Tx chief ray axis. The optical wedge refracts a BPLO beam at a second angle relative to the Tx chief ray axis. The second angle is different from the first angle. A system lens receives the Tx beam and the BPLO beam according to a symmetric beam footprint on the system lens.

A LiDAR system that includes an array of optical wedges is disclosed herein. The LiDAR system configured to transmit, along respective Tx chief ray axes, a plurality of Tx beams including a first Tx beam and a second Tx beam. The plurality of Tx beams are, in either order, passed through an array of source lens and contacted to the array of optical wedges. Each source lens in the array of source lenses is centered about the respective Tx chief ray axes. The array optical wedges directs the first Tx beam and the second Tx beam at a same first angle from an LO window. The array of optical wedges refracts a plurality of BPLO beams including a first BPLO beam and a second BPLO beam. The plurality of BPLO beams are refracted at a same second angle from the LO window. A system lens receives the plurality of Tx beams and the plurality of BPLO beams according to a symmetric beam footprint on the system lens.

### BRIEF DESCRIPTION OF THE DRAWINGS

For a more complete understanding of various examples, reference is now made to the following detailed description taken in connection with the accompanying drawings in which like identifiers correspond to like elements:

FIGS. 1A-1B illustrate diagrams of beam walk-off in mirror scanning coherent LiDAR systems, according to embodiments of the present disclosure.

FIG. 2 illustrates a diagram of an optical lens model including chief ray traces for the Tx beam and BPLO beam, according to embodiments of the present disclosure.

FIG. 3 illustrates a diagram of an optical lens model with decentered arrayed source lenes, according to embodiments of the present disclosure.

FIG. 4 illustrates a diagram of an optical lens model with tilted parallel plates, according to embodiments of the present disclosure.

FIGS. 5A-5B illustrate diagrams of an optical lens model with an optical wedge used in a confocal LO system, according to embodiments of the present disclosure.

FIG. 6 illustrates a diagram of an optical lens model with an optical wedge used in a collimated LO system, according to embodiments of the present disclosure.

FIGS. 7A-7B include diagrams illustrating the impact of a time delay on the BPLO beam, according to embodiments of the present disclosure.

FIG. 8 illustrates a flowchart of a method of using an optical wedge in a LiDAR system, according to embodiments of the present disclosure.

FIG. 9 illustrates a flowchart of a method of using an array of optical wedges in a LiDAR system, according to embodiments of the present disclosure.

### DETAILED DESCRIPTION

A light detection and ranging (LiDAR) system lens may be used to collimate transmit (Tx) beams into free space and collect receive (Rx) beams returning from a target. The system lens footprint is determined by a back projected LO (BPLO) beam and Tx beam footprint projected from a source lens. For descan compensation/minimizing a beam walkoff at the target and improving the beam overlapping for coupling, the beam offset between the BPLO beam and the Tx beam should be reduced/minimized at the target plane.

An angle may be produced between the BPLO beam and Tx beam chief ray from a local oscillator (LO) window surface where the LO beam is generated. Tilting the LO window relative to the Tx beam is one technique for descan compensation. For example, tilted parallel plate(s) relative to the Tx beam direction may be implemented at the LO window to form the angle between the BPLO beam and the Tx beam. However, a tilted plate may cause an imbalanced/off-centered BPLO/Tx beam footprint on the system lens. The off-centered distribution of the beams on the system lens may decrease mixing performance for beams close to the system lens edge, with more aberration, as there are multiple Tx beams. For a round-shaped molded system lens, the off-centered beam footprint may also require a size of the system lens to be increased. Decentering source lens(es) is another technique for descan compensation. Similar to the titled plates, an angle is produced between the BPLO beam and Tx beam chief ray from the LO window surface where the LO beam is generated. Decentering the source lens refers to the source lens being positioned off center from the Tx beam chief ray, which can lead to Tx beam aberration impacting a beam quality of the Tx beams propagated into free space. Decentered the source lenses may also require additional production considerations, as center alignment is initially implemented for the generated optical beams.

Accordingly, an optical wedge may be implemented at the LO window to form the angle between the BPLO beam and the Tx beam at the LO window surface. The optical wedge provides a symmetric BPLO/Tx beam footprint on the system lens without having to decenter the source lens(es). The improved beam footprint of the Tx and BPLO beams on the LiDAR system lens enables a more balanced performance as well as a smaller system lens size compared to tilted parallel plate designs. In contrast to tilting the parallel plates from a datum, there is no need to tilt the optical glass wedge. The wedge itself is a prism that already includes an apex angle for producing the angle between the Tx and BPLO beams. Further, aberrations can be reduced in comparison to decentering the source lenes, in view of the source lenses being centralized along the Tx chief ray axis when implemented in association with the optical wedge.

The optical wedge directs/bends the Tx chief ray either up or down at the LO window, while directing/bending the BPLO chief ray down or up as a mirror reflection of the Tx chief ray. The Tx chief ray and the BPLO chief ray are propagated from the optical wedge located at the LO window to contact the system lens in a symmetrical manner. The optical wedge has only one molded surface (e.g., in contrast to the two molded surfaces of a parallel plate array) and a common flat surface for alignment at the LO window, which reduces production cost and complexity.

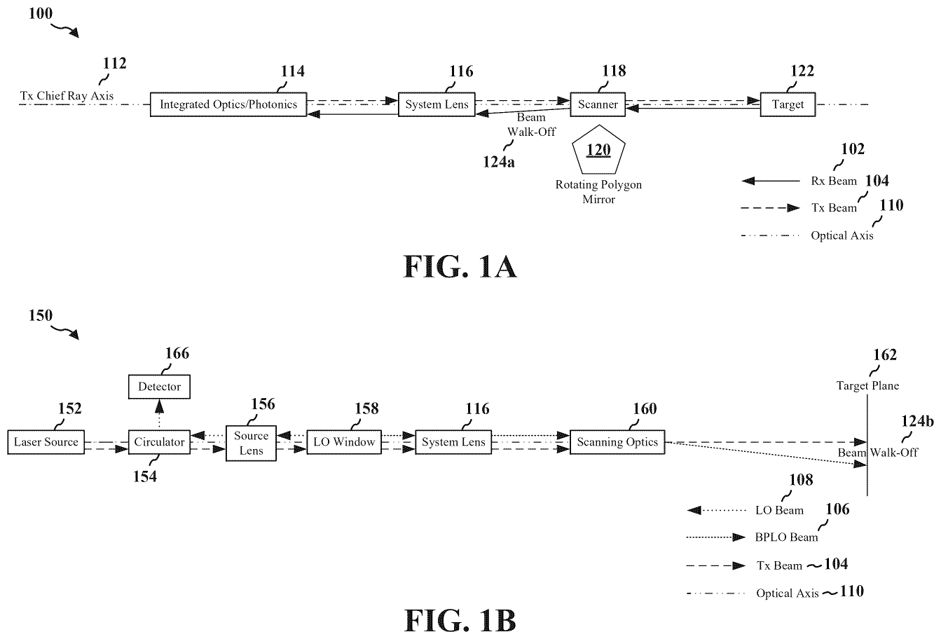

FIGS. 1A-1B illustrate diagrams 100-150 of beam walk-off 124a-124b in mirror scanning coherent LiDAR systems, such as for frequency modulated continuous wave (FMCW) LiDAR. Beam walk-off refers to a misalignment between a Tx beam 104 and an Rx beam 102 or BPLO beam 106. The misalignment creates an angle from the Tx beam 104 that may cause the signal returning from the target 122 or target plane 162 to miss the scanner 118 or scanning optics 160, resulting in a loss of the signal and/or reduced LIDAR system performance. For example, the LIDAR system may detect a reduced amount of returning light to the system, which can decrease the accuracy and range of the LiDAR system.

The LiDAR system may experience time-of-flight delay effects for the light that is propagated between the target 122/target plane 162 and the scanner 118/scanning optics 160. BPLO techniques may be implemented to track the time delay effects on the light. For example, to improve the detection of objects (e.g., at further away distances), the LiDAR system may attempt to have the BPLO beam 106 be overlapped with the Tx beam 104 at the target plane 162 based on a same or similar transmission angle from the scanning optics 160. In some examples, unless compensation techniques are implemented in the system optics design, there may be a large beam walk-off 124b between the BPLO beam 106 and the Tx beam 104, particularly if the target plane 124b is far away from the LiDAR system.

The diagram 100 illustrates a coaxial LiDAR system, where a Tx chief ray axis 112 is aligned with an optical axis 110 of the LiDAR system. Along the Tx chief ray axis 112, the Tx beam 104 is received by integrated optics/photonics 114, which may correspond to a chip including two or more photonic components that form a functioning circuit. Following the integrated optics/photonics 114, the Tx beam 104 is received by free space optics, such as a system lens 116 or other lens. In some examples, the system lens 116 is referred to as an L3 lens. The free space optics (e.g., (system) lens 116) directs the Tx beam 104 to a scanner 118, which further provides the Tx beam 104 to a target 122.

The Tx beam 104 reflects off the target 122, such that the reflection becomes an Rx beam 102 for the LIDAR system at the scanner 118. The Rx beam 102 is communicated back through the system in the reverse direction from which the Tx beam 104 was communicated through the system. However, as a result of the time-of-flight delay between transmitting the Tx beam 104 from the scanner 118 and receiving the returning Rx beam 102 from the target 122, and because a rotating polygon mirror 120 in the scanner 118 is continuously scanning, a changed position of the rotating polygon mirror 120 over the time delay may generate a beam walk-off 124a for the Rx beam 102 that contacts the rotating polygon mirror 120. The beam walk-off 124a resulting from the time-of-flight delay of the transmitted and received light may create an angular difference between the Tx beam 104 and the Rx beam 102 at the system lens 116. The angular difference may cause the Rx beam 102 to be offset from the Tx beam 104 between the system lens 116 and the integrated optics/photonics 114.

The diagram 150 illustrates an LO beam 108 in addition to the Tx beam 104 and the BPLO beam 106. A laser source 152 transmits the Tx beam 104 along the optical axis 110 of the LiDAR system. The LO beam 108 illustrated in the diagram 150 is a beam that reflects off a beam splitter, which is sometimes referred to as an LO window 158, when the Tx beam 104 contacts the LO window 158. The LO window 158 directs the LO beam 108 back towards a detector 166. The BPLO beam 106 is a beam that also arrives at the detector 166 but is back projected/reversed from the LO beam 108. That is, the wave/rays are flipped around and propagated back through the system. Hence, if the BPLO beam 106 is propagated from the LO window 158 at a 0 degree angle along the optical axis 110, the LO beam 108 would have an exact opposite angle from the BPLO beam 106 at a 180 degree angle along the optical axis 110. Unlike the LO beam 108, the BPLO beam 106 is propagated all the way to the target plane 162 and back projected to the LO window 158/beam splitter surface before being communicated to the detector 166. Such techniques can oftentimes be suitable in examples where there is no clipping of the LO beam 108 on the path to the detector 166.

The LO beam 108 should be reversed at the detector 166, as opposed to reversal at the LO window 158. However, in principle, if there is no beam clipping along the path between the LO window 158 and the detector 166, the LO beam 108 could be reversed at any place in the system (e.g., LO window 158, source lens 156, circulator 154, etc.) to achieve the same result.

In a coupling efficiency calculation, a product of the detector mode field/LO field times the Rx field provides a complex field. The product is then summed to indicate how much of the light is mixing (i.e., the mixing efficiency). The mixing efficiency is proportional to the signal-to-noise ratio (SNR). However, for incoherent backscattered LiDAR, the mixing efficiency may be calculated differently due to various coherence effects. In such examples, the mixing efficiency may be calculated based on an overlap integral of the BPLO irradiance times the Tx irradiance at the target 122. That is, the irradiance values of the two beams (e.g., Gaussian beams) are multiplied pixel-by-pixel and then summed. The result is proportional to the mixing efficiency and the SNR. The BPLO beam 106 is propagated all the way to the target 122 and, in order to maximize the signal, the angles of the BPLO beam 106 and the Tx beam 104 should be directly on top of each other (i.e., the same angle).

The effects of the time delay of the light are experienced via the rotating polygon mirror 120 in the scanning optics. Because the rotating polygon mirror 120 is spinning continuously, the time that it takes for the light to be propagated to the target 122 and back to the scanner 118 allows the rotating polygon mirror 120 to advance by some amount. Thus, the Rx beam 102 coming back from the target 122 contacts the rotating polygon mirror 120 at a different angle at which the Tx beam 104 contacted the rotating polygon mirror 120 and causes an angular difference to occur between the LO beam 108 and the BPLO beam 106 at the detector 166. Hence, the BPLO beam angle is affected by the time-of-flight delay, since the Rx beam 102 contacts the rotating polygon mirror 120 later in time than the Tx beam 104. The BPLO beam 106 experiences a beam walk-off 124b with respect to the Tx beam 104 from the descan effects/time lag. The returning Rx beam 102 experiences an Rx beam walk-off 124a caused by the time lag/time delay for the optical signal to travel between the rotating polygon (scanning) mirror 120 and reflection target 122. For coherent LiDAR system detection, the LO beam 108 can be mixed with the Rx beam 102. The BPLO beam 106 can also be mixed with the Tx beam 104. A beam walk-off 124b is illustrated in the diagram 150 between the BPLO beam 106 and the Tx beam 104. The LO window 158 includes a glass plate that generates a partial split of the Tx beam 104 into the LO beam 108. The circulator 154 is used to direct the returning LO beam 108 to another location (e.g., the detector 166), instead of back to the laser source 152.

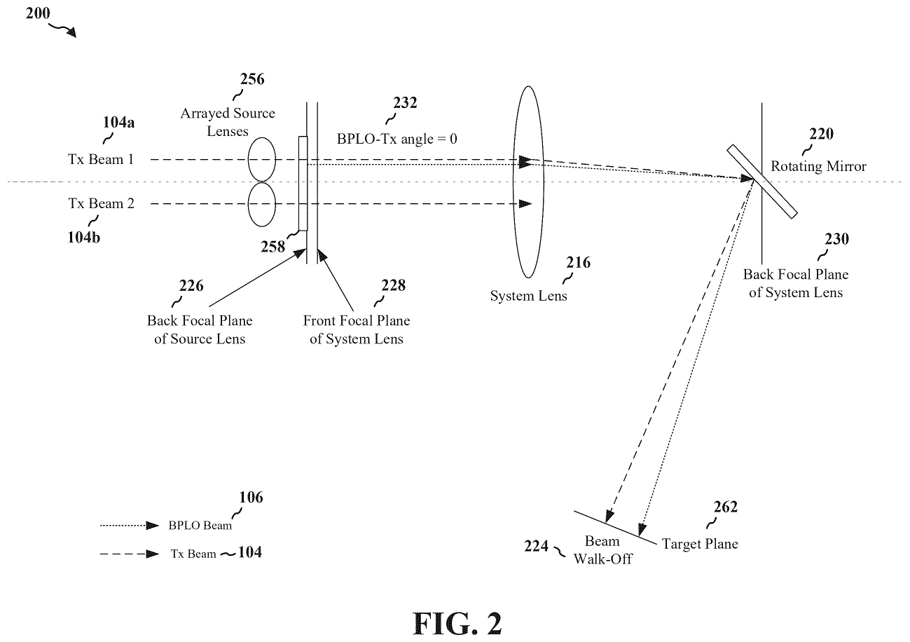

FIG. 2 illustrates a diagram 200 of an optical lens model. The optical lens model includes chief ray traces for the Tx beam 104 and the BPLO beam 106. Multiple source lenses 256 are arranged in an array for receiving multiple Tx beams 104. The arrayed source lenes 256 are used to focus the Tx beams 104 toward a system lens 216. The system lens 216 is a single lens element that collimates the Tx beams 104 onto a scanning mirror with an angular spacing between the Tx beams 104 at the scanning mirror.

In the diagram 200, a plurality of Tx beams 104 (e.g., Tx beam 1 104a and Tx beam 2 104b) are transmitted along the optical axis of the LiDAR system to the arrayed source lenses 256. The arrayed source lenses 256 direct Tx beam 1 104a and Tx beam 2 104b toward an LO window 258. The LO window 258 includes a glass plate with an anti-reflective (AR) coating on the front surface of the glass plate and a partially reflective coating on the back surface of the glass plate. The back surface of the glass plate corresponds to the back focal plane 226 of the arrayed source lenses 256. When the Tx beam 1 104a contacts the LO window 258, a BPLO beam 106 is refracted from the LO window 258 at an angle relative to the Tx beam angle. For example, in the diagram 200, the BPLO-Tx angle 232 is equal to 0 degrees.

The Tx beam 104 and the BPLO beam 106 are propagated through a front focal plane 228 of the system lens 216 and onto the system lens 216. The system lens 216 redirects the Tx beam 104 and the BPLO beam 106 towards a rotating mirror 220 (e.g., at a different angle than which the system lens 216 received the Tx beam 104 and the BPLO beam 106 from the LO window 258). The rotating mirror 220 is located at a back focal plane 230 of the system lens 216. The rotating mirror 220 in the LiDAR system may have a fast rate of rotation. For example, the rotating mirror 220 may complete 20-30 cycles each second (e.g., 20-30 revolutions per second (RPS)).

After the mixing efficiency is calculated, beam overlap integration is determined on the target plane 262, rather than on the detector, for incoherent backscattered LIDAR. The BPLO beam 106 that reflects back to the rotating mirror 220 experiences the rotation lag or delay associated with the mirror rotation which, on the target plane 262, corresponds to a beam offset/beam walk-off 224 between the Tx beam angle and the BPLO beam angle when considering the overlap integration. Thus, the Tx beam 104 and the BPLO beam 106 are not aligned on the target plane 262 without performing a compensation for the rotation lag/time of flight delay. Non-alignment between the Tx beam 104 and the BPLO beam 106 can lead to a poor mixing efficiency.

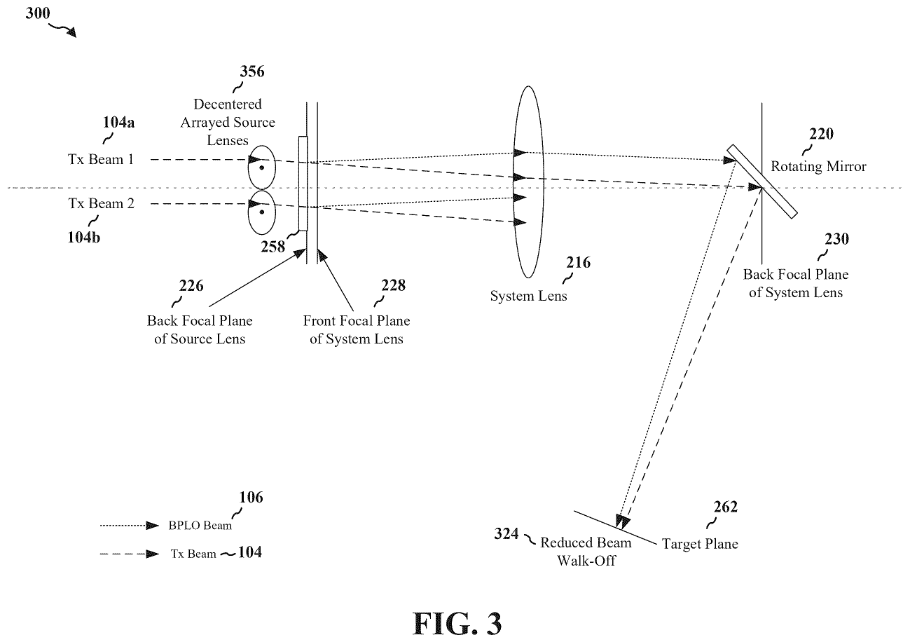

FIG. 3 illustrates a diagram 300 of an optical lens model with decentered arrayed source lenes 356. The decentered arrayed source lenses 356 can be used for descan compensation and reduced beam walk-off 324 between the Tx beam 104 and the BPLO beam 106 at the target plane 262. However, decentered lenes create further considerations for lens designs. For example, the apertures for the decentered arrayed source lenes 356 may cause clipping or abrasion of Tx beam 1 104a and Tx beam 2 104b due to the aperture being off-center from the optical axis, Nevertheless, decentered lens techniques may still allow for the offset between the BPLO beam 106 and the Tx beam 104 at the target plane 262 to have a reduced beam walk-off 324 (e.g., zero walk-off), albeit with certain drawbacks associated with the clipping and/or abrasion of the Tx beam 104 via the decentered arrayed source lenses 356.

In cases of multiple Tx beams 104 (e.g., Tx beam 1 104a and Tx beam 2 104b) for arrayed source lenes, the Tx beams 104 are typically directed through the center of their respective source lenes. However, in some examples, the source lenes are decentered to compensate for the lag effects/descan to reduce the beam walk-off 324 at the target plane 262. In the diagram 300, the decentered arrayed source lenes 356 bend the Tx beams 104a-104b at a downward angle towards the LO window 258 based on their decentered position with respect to the Tx beams 104a-104b.

The back of the LO window plate is located at the back focal plane 226 of the decentered arrayed source lenses 356. When the Tx beams 104 contact the LO window 258, the BPLO beam 106 is refracted at an angle relative to the Tx beam angle from the decentered arrayed source lenes 356. The LO beam (not shown in FIG. 3) is reflected from the LO window 258 in a mirror opposite direction of the BPLO beam 106. The angle created between the BPLO beam 106 and the Tx beam 104 can change based on how far off-center (e.g., up or down) the decentered arrayed source lenses 356 are from the income Tx beams 104. The Tx beam 104 and the BPLO beam 106 are propagated through the front focal plane 228 of the system lens 216 and onto the system lens 216.

The system lens 216 redirects the Tx beam 104 and the BPLO beam 106 towards the rotating mirror 220. The angles at which the Tx beam 104 and the BPLO beam 106 are redirected by the system lens 216 is different in the diagram 300 from the angle at which system lens redirected the Tx beam 104 and the BPLO beam 106 in the diagram 200. The rotating mirror 220 that receives the Tx beam 104 and the BPLO beam 106 is similarly located at the back focal plane 230 of the system lens 216. In the diagram 300, the Tx beam 104 and the BPLO beam 106 may be aligned on the target plane 262 with a reduced beam walk-off 324, but suffer from the effects of clipping and/or abrasion caused by the decentered arrayed source lenses 356.

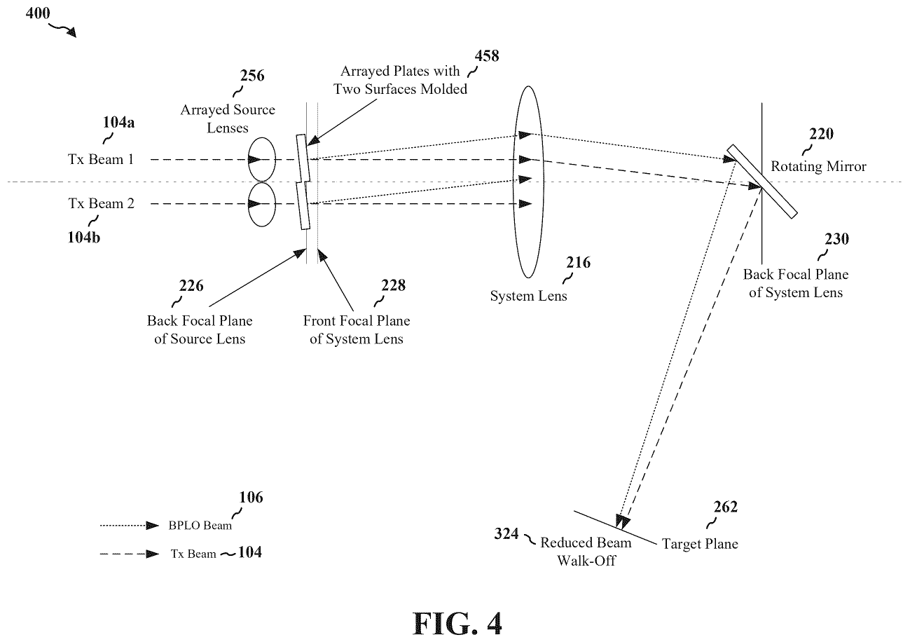

FIG. 4 illustrates a diagram 400 of an optical lens model with tilted parallel plates 458. The tilted plates allow for compensation of the lag effects/descan to reduce the offset/beam walk-off 324 between the Tx beam 104 and the BPLO beam 106 at the target plane 262 without having to decenter the arrayed source lenses 256. Tx beam 1 104a and Tx beam 2 104b are propagated through the center of the arrayed source lenses 256 in the diagram 400 without experiencing the drawbacks of clipping or abrasion associated with decentered lenses.

The parallel pates 458 are tilted at the LO window to create an angular difference between the BPLO beam 106 and the Tx beam 104 for reducing the offset/beam walk-off 324 at the target plane 262. The parallel plates 458 are arrayed plates with two surfaces molded and located at the back focal plane 226 of the source lenses 256. For example, the arrayed plates 458 may be fabricated with a zig-zagged surface profile to provide the LO window for the respective Tx beams 104. However, performing fabrication on both sides of the surface profile may increase the complexity of the fabrication process in comparison to flat surfaces. Further, the BPLO beam 106 is more off-center from the system/optical axis (e.g., Tx chief array axis) than in examples, such as the diagram 300, where the arrayed source lenses are decentered.

The more off-centered nature of the BPLO beam 106 may have a more negative impact on the beam footprint from a perspective of the system lens 216, as a symmetric lens overlap on the system lens 216 may provide for a better system design. The Tx beam 104 and the BPLO beam 106 are propagated through the front focal plane 228 of the system lens 216 and onto the system lens 216. The system lens 216 redirects the Tx beam 104 and the BPLO beam 106 towards the rotating mirror 220. The angles at which the Tx beam 104 and the BPLO beam 106 are redirected by the system lens 216 is different in the diagram 400 from the angle at which system lens redirected the Tx beam 104 and the BPLO beam 106 in the diagram 300. The rotating mirror 220 that receives the Tx beam 104 and the BPLO beam 106 is similarly located at the back focal plane 230 of the system lens 216. In the diagram 400, the Tx beam 104 and the BPLO beam 106 may be aligned on the target plane 262 with a reduced beam walk-off 324, but suffer from the effects of being non-symmetric relative to the system lens 216.

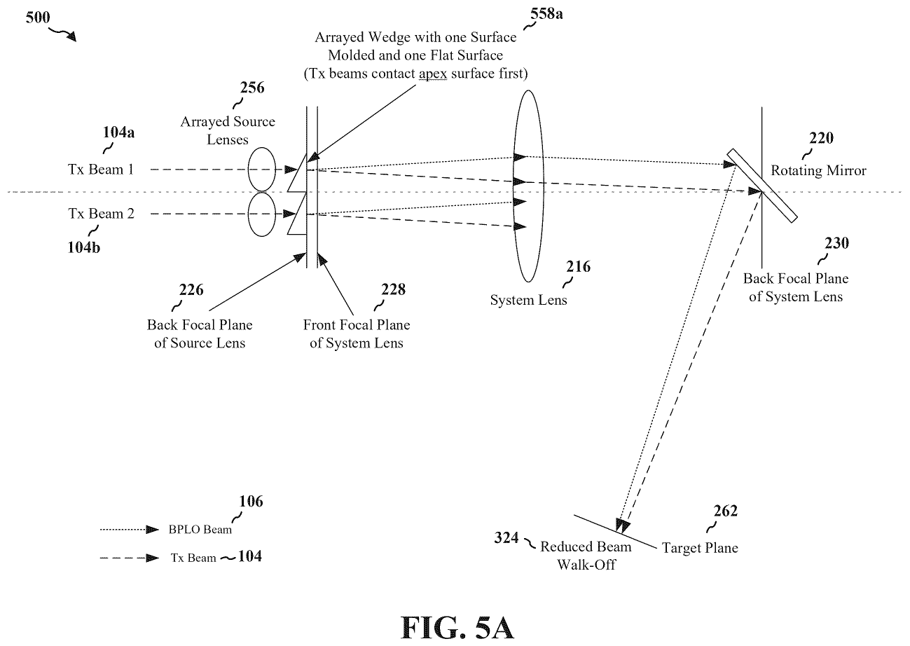

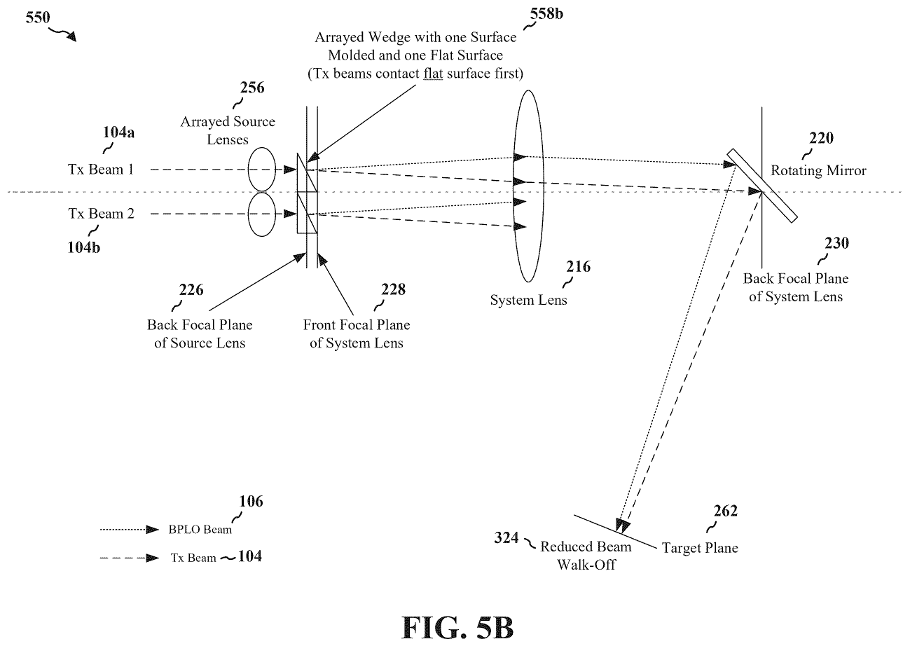

FIGS. 5A-5B illustrate diagrams 500-550 of an optical lens model with optical wedges 558a-558b used in a confocal LO system. The optical wedge 558 can be used for descan compensation and reduced beam walk-off 324 between the Tx beam 104 and the BPLO beam 106 at the target plane 262. The optical wedge 558 is implemented to allow for centering of the arrayed source lenses 256 without the drawbacks of having to fabricate a zig-zagged surface profile of glass (parallel) plates at the LO window. The optical lens model is implemented with an array of optical wedges 558 having one surface molded and a flat (e.g., vertical) surface. In the diagram 500, the Tx beams 104 contact the apex surface of the optical wedges 558a. In the diagram 550, the Tx beams 104 contact the flat surface of the optical wedges 558b. The arrayed optical wedges 558 respectively correspond to the arrayed source lenses 256.

Similar to the diagram 400, Tx beam 1 104a and Tx beam 2 104b are propagated along the optical axis through the center of the arrayed source lenses 256 in the diagrams 500-550 to reduce clipping and/or abrasion that may occur in association with having decentered lenses 356, as illustrated in the diagram 300, Tx beam 1 104a and Tx beam 2 104b contact the array of optical wedges 558 after respectively passing through the arrayed source lenses 256.

The optical wedges 558 are implemented at the LO window to form the angle between the BPLO beam 106 and the Tx beam 104 from the LO window. For example, the flat (back) surface of the optical wedge 558a in the diagram 500 is aligned with the back focal plane 226 of the arrayed source lenses 256. In another example, the flat surface is a front surface of the optical wedge 558b, as illustrated in the diagram 550. The optical wedge 558 is shaped as a prism and includes an apex angle for producing the angle between the BPLO beam 106 and the Tx beam 104.

After the Tx beams 104 and the BPLO beams 106 pass through the array of optical wedges 558, the Tx beams 104 and the BPLO beams 106 are propagated through the front focal plane 228 of the system lens 216 and onto the system lens 216. The system lens 216 redirects the Tx beam 104 and the BPLO beam 106 towards the rotating mirror 220 based on a symmetric distribution about the system lens 216. The rotating mirror 220 that receives the Tx beam 104 and the BPLO beam 106 is located at the back focal plane 230 of the system lens 216. The Tx beam 104 and the BPLO beam 106 are aligned on the target plane 262 with a reduced beam walk-off 324 and, unlike the diagram 400, contact the rotating mirror 220 based on the symmetric distribution about the optical axis and do not suffer from the effects of being non-symmetric relative to the system lens 216.

The array of optical wedges 558 provide a symmetric BPLO/Tx beam footprint on the system lens 216 about the optical axis without having to decenter the source lens(es) 256. The centralized beam footprint of the Tx beams 104 and the BPLO beams 106 on the LiDAR system lens 216 enables a more balanced/improved performance as well as a smaller system lens size compared to tilted parallel plate designs that generally do not center the BPLO/Tx beam footprint on the system lens 216 about the optical axis. Centralizing the arrayed source lenses 256 along the optical axis reduces aberration in comparison to implementations that include decentered source lenses 356.

The optical wedge 558 directs/bends the Tx chief ray either up or down at the LO window, while directing/bending the BPLO chief ray down or up as a mirror reflection of the Tx chief ray. For example, the diagrams 500-550 illustrate the optical wedges 558 directing/bending the Tx beams 104 downward from the LO window due to the prism shape of the wedges 558. The refraction created from the optical wedges 588 forms the angle of the BPLO beams 106 relative to the Tx beams 104. In the diagrams 500-550, the optical wedges 558 direct/bend the BPLO beams 106 upward from the LO window. It should be appreciated that optical wedges 558 of different orientations and/or angles can provide different up or down directions and/or angles for the Tx/BPLO beams 104/106 from the LO window.

The optical wedge 558 has only one molded surface (e.g., in contrast to the two molded surfaces of a parallel plate array) and a common flat surface, which reduces both production cost of the optical wedge 558 and complexity of the LO window path. The refraction associated with the BPLO beams 106 is provided via the optical wedges 558, such that a same compensating factor at the target plane 262 can be applied for the beams 104/106 to minimize the beam walk-off 324, One side of the optical wedge 558 is tiered with the apex angle, while the other side of the optical wedge 558 is straight/vertical. Thus, the optical wedge 558 can be fabricated flat on one side (and also on the bottom), but with an angled surface profile along the other side of the optical wedge 558.

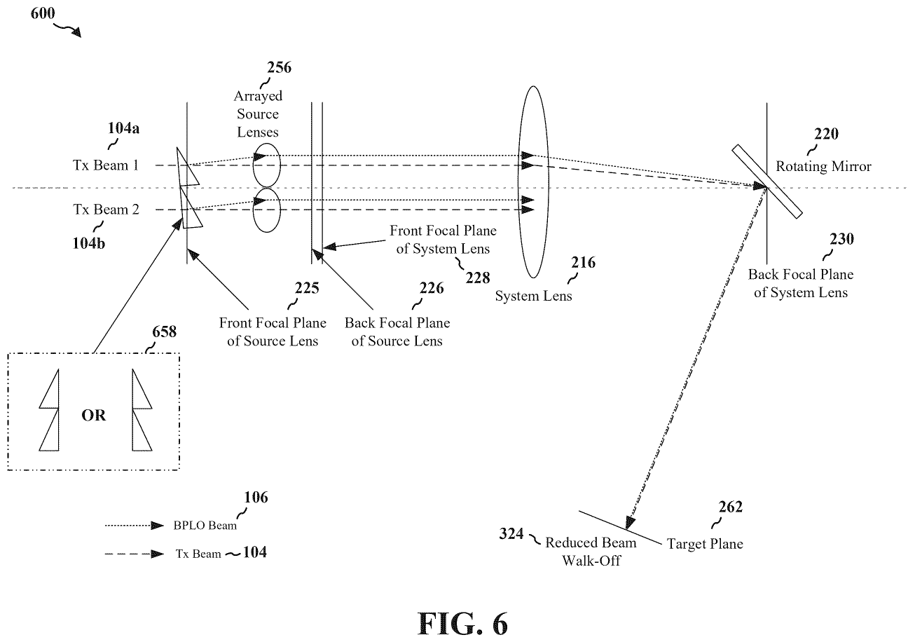

FIG. 6 illustrates a diagram 600 of an optical lens model with an optical wedge used in a collimated LO system. Elements 104, 106, 216, 220, 226, 228, 230, 256, 262, and 324 have already been discussed with respect to the previous figures.

In the collimated LO system of the diagram 600, the optical wedges 658 are located at a front focal plane 225 of the source lenses 256. The optical wedges 658 may be oriented such that either the apex surface or the flat surface of the optical wedge 658 may face the incoming Tx beams 104 being propagated into the optical wedges 658. The optical wedges 658 can also be tilted at a forward or backward angle relative to the front focal plane 225 of the source lenses 256. For example, in the diagram, 600, the optical wedges 658 located at the front focal plane 225 of the source lenses 256 are tilted at a forward angle towards the incoming Tx beams 104.

Tilting the optical wedges 658 may be used to create/manipulate the angle between the Tx beam 104 and the BPLO beam 106 propagated from the front focal plane 225 of the source lenses 256. The optical wedge 658 may be implemented so that only one side of the refraction is detected as LO and another side of the refraction, at a different angle, is not detected. The Tx beams 104 pass through the center of the arrayed source lenses 256, whereas the BPLO beams 106 are angled from the optical wedges 658 and may contact the arrayed source lenses 256 at an off-center location. In some examples, such as illustrated in the diagram 600, the Tx beam 104 and the BPLO beam 106 can be propagated through the system lens 216 and contact the rotating mirror 220 in such a way that they are aligned on the target plane 262.

The compensation scheme associated with the optical wedge 558/658 provides an improved design for LiDAR systems, such as FMCW LiDAR, An advantage of the optical wedge 558/658 is that the Tx beams 104 and the BPLO beams 106 are symmetric about the optical axis/system lens 216 without having to decenter the L2 arrayed source lenses 256. For example, one set of Tx beams (e.g., Tx beams 1 104a) is above the optical system axis and another set of Tx beams (e.g., Tx beams 2 104b) is below the optical system axis in a symmetric manner, such that the beams are centrally distributed at the L3 system lens 216. The central distribution of the beams 104/106 allows the overall size of the system lens 216 to be reduced while also reducing the impact of aberrations.

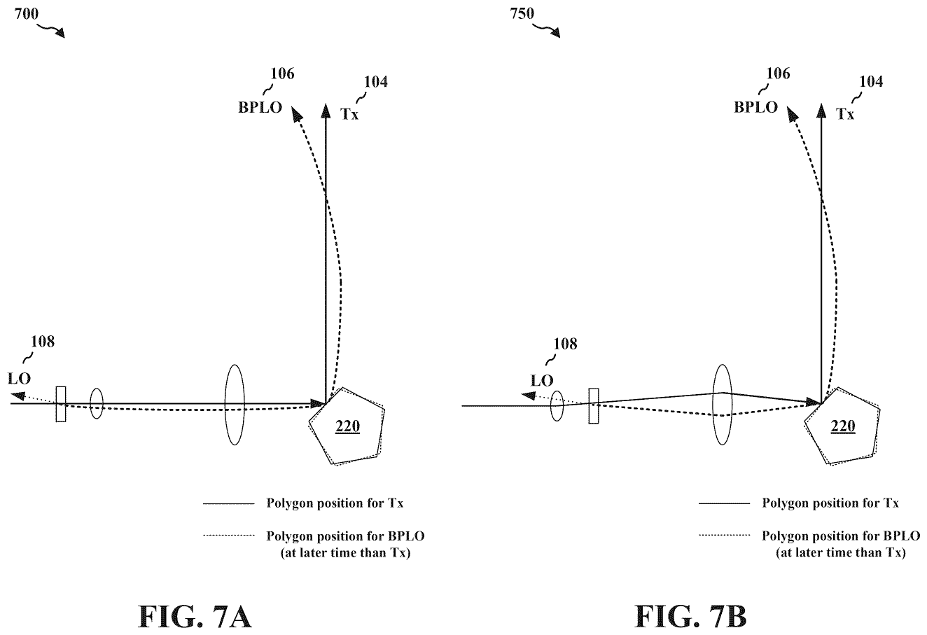

FIGS. 7A-7B include diagrams 700-750 illustrating the impact of a time delay on the BPLO beam 106. In particular, the diagram 700 illustrates the impact of a time delayed rotating polygon 220 on the position of the BPLO beam 106 in a collimated LO arrangement (e.g., associated with FIG. 6). The diagram 750 illustrates the impact of the time delayed rotating polygon 220 on the position of the BPLO beam 106 in a confocal LO arrangement (e.g., associated with FIGS. 5A-5B).

An LO beam splitter can be implemented to perform descan compensation in FMCW LiDAR systems. For example, the LO beam splitter may be placed in the LiDAR system to provide descan (or time lag) compensation when scanning for FMCW LiDAR, while reducing a size of the system, a sensitivity of L3 alignment, and/or a sensitivity to laser damage. The LO beam splitter is placed in the collimated space between a Faraday rotator (e.g., quarter wave plate) and the L2. Descan compensation is achieved by controlling the angle of incidence of the Tx beam 104 on the beam splitter surface. This further results in a smaller scanner aperture, reduced sensitivity to L3 focus, and reduced sensitivity to a laser damage threshold at the LO beam splitter.

The LiDAR system may include various components, such as semiconductor optical amplifiers (SOAs), beam collimating optics (e.g., LIS and L1W), beam patterning optics (e.g., slide and hop periscopes), a polarizing beam splitter (PBS), the Faraday rotator, the lenses (e.g., L2, and L3), photodiodes (PDs), and a scanner, which may be implemented in many ways including as a slow galvo-mirror and a fast-spinning polygon 220. The LO beam splitter divides a portion of the incident light into reflected beams that propagate to the PDs (e.g., one for each beam). Each of the beams are referred to as an LO beam 108. The LO beams 108 may be tilted relative to the incident beam when the LO beam splitter is tilted by an angle, and the reflected LO beams 108 are then tilted by twice this angle.

The beams transmitted from the LO beam splitter are referred to as Tx beams 104, and are undeviated in angle by the LO beam splitter, unless the beam splitter includes a wedge angle. The BPLO beam 106 is determined by reversing the beam that arrives at the PD and propagates into the same space as the Tx beam 104. An Rx beam 102 (not shown in FIGS. 7A-7B) is comprised of the light from the Tx beam 104 that is reflected or scattered by a target. A portion of the Rx beam is received by a LiDAR receiving aperture, and mixed with the LO beam 108 at the detector. However, not all the Rx light received by the aperture produces an interference signal. Rather, the Rx light that follows the BPLO path may contribute to the FMCW signal and produce interference, and Rx light outside the BPLO path contributes to noise. The system may be most sensitive to Rx light where the BPLO irradiance is highest.

A product of the Tx and BPLO irradiance at the target determines the mixing efficiency. The signal-to-noise ratio (SNR) of an FMCW LiDAR system is proportional to the mixing efficiency. In a coherent backscatter heterodyne LiDAR system, the target causes scattering and generates speckle. During system scans, the speckle is averaged out, but still has an impact on the mixing efficiency calculation due to a time average over the changing complex field (e.g., amplitude and phase) received by the optics. The speckle effects can be simplified by evaluating the mixing efficiency as an integral over the product of the Tx and BPLO beam irradiances at the scattering target, provided that the integration time is sufficiently long. The mixing efficiency is improved when the Tx beam 104 and BPLO beam 106 are centered on each other at the target and/or when the beams 104/106 (e.g., one or both) have a small footprint at the target.

During the time lag T that it takes for the light to travel to and from the target at distance R, the scanner will change its direction. The time lag corresponds to T=2R/c, where c is the speed of light. The polygon 220, which spins at a number of rotations per second (RPS), advances its angle by RPS*T=RPS*2R/c.

In the context of the BPLO-Tx model, the Tx beam 104 reflects at a first angle and the BPLO beam 106 reflects at a second angle determined by the scanning speed and the travel time T. Furthermore, assuming the Tx beams 104 and BPLO beams 106 are coincident at the scanner, a displacement D between the Tx beams 104 and the BPLO beams 106 at the target is approximately equal to the product of the distance and the scan angle change, which may be determined via D=2*RPS*T*R=4RPS*R\hat{ }2*c. The BPLO-Tx separation at the target may be quadratic with range, such that there are, at most, two target distances where the Tx beam 104 and the BPLO beam 106 are centered on each other. Whether or not there are one or two such overlap distances depends on the relative position and angle of the Tx beam 104 and BPLO beam 106 at the scanner, which in turn depends on the positioning of the LO beam splitter in the system.

The efficacy of the descan compensation method may partly depend on the maximum distance between the BPLO beam 106 and the Tx beam 104 within the expected target ranges of the system, which may further partly depend on how the LO beam splitter is placed in the system. In a confocal LO placement strategy, such as illustrated via the diagram 750, the LO beam splitter is near the front focal plane of L3 and is therefore imaged to a position relatively far from the polygon 220 in relation to a real image somewhere downstream of the polygon 220 or to a virtual image behind the polygon 220 from the perspective of the target. It is also possible to use a confocal LO location, such illustrated via the diagram 700, that is conjugate to the polygon 220. However, this tends to lead to very small apertures and low mixing efficiency due to diffraction spreading of the beam with range.

Accordingly, the LO beam splitter is placed in the collimated space between the Faraday rotator and L2, which may be referred to as collimated LO (placement). A difference between the collimated and confocal approaches is that the collimated LO beam splitter is imaged to a real position close to the back focal plane of L3, which can be close to the scanner/polygon 220. Therefore, a first Tx-BPLO overlap location is set at or near the scanner/polygon 220. A second Tx-BPLO overlap location can then be set by adjusting the angle between the Tx beam 104 and the BPLO beam 106, which is determined by the angle of incidence on the LO beam splitter. When the LO beam splitter is placed in collimated space at the front focal plane of L2, the BPLO beam 106 and Tx beam 104 come to focus at a same distance from L2 and maintain the same separation at all distances from L2 (i.e., telecentric), so that the distance between L2 and L3 does not impact the angle between the two beams.

In contrast, the confocal LO often includes a separation between the Tx beam 104 and the BPLO beam 106 at the scanner, and the angle between the Tx beam 104 and BPLO beam 106 depends on both the angle of incidence at the LO beam splitter as well as the distance between the LO beam splitter and L3, which determines the real or virtual LO beam splitter image location. For this reason, in practice, maximizing mixing efficiency over range, in the confocal LO case requires careful adjustment of the angle of incidence at the LO beam splitter, as well as the distance between the LO beam splitter and L3.

Because the BPLO-Tx crossing ranges depends on the angle of incidence (AOI) at the LO beam splitter surface, a method for choosing the best AOI may be needed. The AOI may be chosen so that the mixing efficiency is balanced across the range of target distances. The mixing efficiency decreases with range, but it is possible to improve the mixing in some ranges at the expense of other ranges based on certain AOI. The AOI can then be based on calculated mixing efficiency and compared with the desired performance, such that the AOI that provides the best balance for an application may be selected.

In addition to the effect of BPLO-Tx separation, the collimated and confocal LO strategies often experience different behavior with respect to focus. For example, the confocal LO arrangement uses L3 position/focus to change the position and angle of the BPLO beam 106 at the scanner to set the two BPLO-Tx crossing distances. The highest mixing efficiency generally occurs when the beams are small, or when the divergence is minimized for large distances. However, in the confocal LO arrangement, there is a tradeoff between beam divergence and BPLO angle. The collimated LO arrangement has no such tradeoff (e.g., when the LO beam splitter is at/near the front focal plane of L2), so that the L3 position that maximizes mixing for large ranges is also the position that minimizes the beam divergence.

The mixing efficiency is impacted by beam shape and size. For ranges were the Tx beam 104 and BPLO beam 106 are coincident on the target, it is advantageous to have both beams be as small as possible. However, for other ranges the beam may separate and result in reduced mixing efficiency. In these cases, it is advantageous to have one or both beams elongated on the target in the direction of the beam separation. This results in increased mixing efficiency at the ranges where the BPLO-Tx separation is large at the expense of decreased mixing efficiency when the BPLO-Tx separation is small.

In general, however, it is often better to have both BPLO and Tx beam divergences that are small for a long-range LiDAR system. To achieve this, a flat LO beam splitter is placed in a position where the beam wavefront is also flat. If not, the curvature acquired by the BPLO beam 106 at reflection will be opposite that of the Tx beam 104, so that the divergence of both beams cannot be minimized simultaneously. It is possible to place the confocal LO at the beam waist between L2 and L3, and this is usually preferred for mixing efficiency. However, a potential issue may arise with laser damage caused by the high beam fluence in this region. The fluence at the LO beam splitter in the collimated LO configuration can be much less, and so the collimated LO configuration is more tolerant to the laser damage threshold of the LO beam splitter material. Accordingly, it is advantageous to place the LO beam splitter close to the same position as the focal plane of L2 and the beam waist (e.g., flat wavefront).

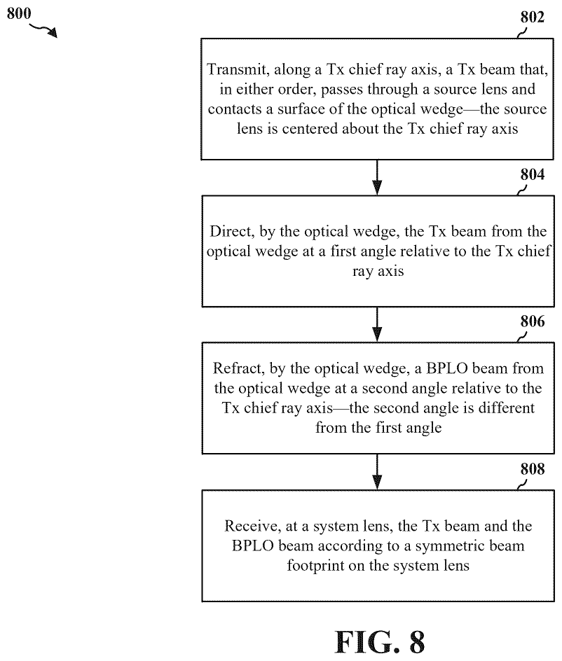

FIG. 8 illustrates a flowchart 800 of a method of using an optical wedge in a LiDAR system. The method begins at block 802, where the LiDAR system transmits, along a Tx chief ray axis, a Tx beam that, in either order, passes through a source lens and contacts a surface of the optical wedge—the source lens is centered about the Tx chief ray axis. For example, referring to FIG. 5, Tx beam 1 104a is transmitted along an axis of Tx beam 1 104a. Tx beam 1 104a passes through a first source lens in the arrayed source lenses 256 and contacts a first optical wedge 558 included in an array of optical wedges. The first source lens in the arrayed source lenses 256 is centered about the axis of Tx beam 1 104a.

At block 804, the LiDAR system directs, by the optical wedge, the Tx beam from the optical wedge at a first angle relative to the Tx chief ray axis. For example, referring to FIG. 5, the first optical wedge 558 in the array of optical wedges changes a direction of Tx beam 1 104a. That is, the first optical wedge 558 bends Tx beam 1 104a at a downward angle towards the system lens 216. The downward angle is relative to the axis of Tx beam 1 104a.

At block 806, the LiDAR system refracts, by the optical wedge, a BPLO beam from the optical wedge at a second angle relative to the Tx chief ray axis—the second angle is different from the first angle. For example, referring to FIG. 5, a first BPLO beam 106 is refracted from the first optical wedge 558 towards the system lens 216 at a second angle. The second angle is mirror opposite angle of the first angle of Tx beam 1 104a. That is, the first optical wedge 558 refracts the first BPLO beam 106 at an upward angle towards the system lens 216 in mirror position to Tx beam 1 104a, the mirror position being about the axis of Tx beam 1 104a.

At block 808, the LiDAR system receives, at a system lens, the Tx beam and the BPLO beam according to a symmetric beam footprint on the system lens. For example, referring to FIG. 5, the system lens 216 receives Tx beam 1 104a and the refracted BPLO beam 106 corresponding to Tx beam 1 104. Tx beam 1 104a and the refracted BPLO beam 106 are associated with a symmetric beam footprint on the system lens 216.

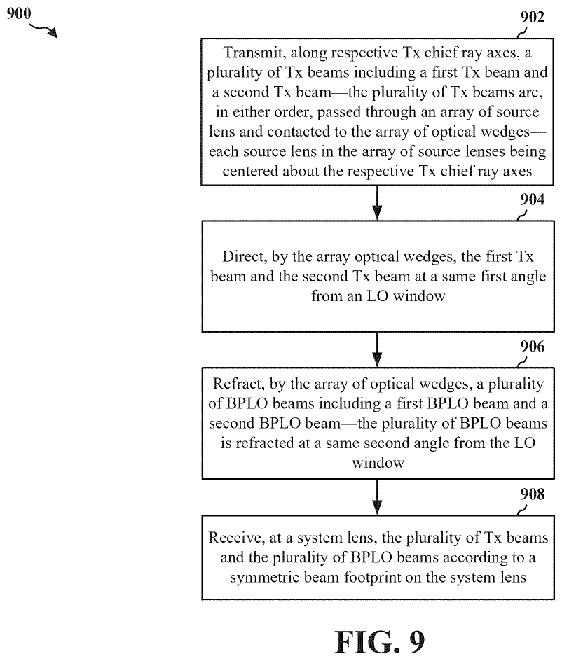

FIG. 9 illustrates a flowchart 900 of a method of using an array of optical wedges in a LiDAR system. The method begins at 902, where the LiDAR system transmits, along respective Tx chief ray axes, a plurality of Tx beams including a first Tx beam and a second Tx beam—the plurality of Tx beams are, in either order, passed through an array of source lens and contacted to the array of optical wedges—each source lens in the array of source lenses being centered about the respective Tx chief ray axes. For example, referring to FIG. 5, Tx beam 1 104a is transmitted along an axis of Tx beam 1 104a and Tx beam 2 104b is transmitted along an axis of Tx beam 2 104b. Tx beam 1 104a passes through a first source lens in the arrayed source lenses 256 and Tx beam 2 passes through a second source lens in the arrayed source lenses 256. Tx beam 1 104a and Tx beam 2 104b contact an array of optical wedges 558. The first source lens in the arrayed source lenses 256 is centered about the axis of Tx beam 1 104a and the second source lens in the arrayed source lenses 256 is centered about the axis of Tx beam 2 104b.

At block 904, the LiDAR system directs, by the array optical wedges, the first Tx beam and the second Tx beam at a same first angle from an LO window. For example, referring to FIG. 5, the array of optical wedges 558 change the direction of Tx beam 1 104a and Tx beam 2 104b. That is, the array of optical wedge 558 bend Tx beam 1 104a and Tx beam 2 104b at a downward angle towards the system lens 216. The downward angles of Tx beam 1 104a and Tx beam 2 104b is a same downward angle relative to the LO window.

At block 906, the LiDAR system refracts, by the array of optical wedges, a plurality of BPLO beams including a first BPLO beam and a second BPLO beam—the plurality of BPLO beams is refracted at a same second angle from the LO window. For example, referring to FIG. 5, a first BPLO beam 106 corresponding to Tx beam 1 104a is refracted from a first optical wedge in the array of optical wedges 558 and a second BPLO beam 106 corresponding to Tx beam 2 104b is refracted from a second optical wedge in the array of optical wedges 558. The first/second BPLO beams are refracted towards the system lens 216 at a same upward angle relative to the LO window. The same upward angle for the BPLO beams 106 is a mirror opposite angle, about the Tx chief ray axes, as the same downward angle for the Tx beams 104a/104b.

At block 908, the LiDAR system receives, at a system lens, the plurality of Tx beams and the plurality of BPLO beams according to a symmetric beam footprint on the system lens. For example, referring to FIG. 5, the system lens 216 receives Tx beam 1 104a and the first refracted BPLO beam 106 corresponding to Tx beam 1 104 together with Tx beam 2 104b and the second refracted BPLO beam 106 corresponding to Tx beam 2 104b. The Tx beams 104a/104b and the corresponding refracted BPLO beam 106 have a symmetric beam footprint on the system lens 216.

The term “computer-readable storage medium” should be taken to include a single medium or multiple media, e.g., a centralized or distributed database and/or associated caches and servers, that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

The following Examples are illustrative only and may be combined with other examples or teachings described herein, without limitation.

Example 1 is a method of using an optical wedge in a LiDAR system, including: transmitting, along a Tx chief ray axis, a Tx beam that, in either order, passes through a source lens and contacts a surface of the optical wedge, the source lens being centered about the Tx chief ray axis; directing, by the optical wedge, the Tx beam from the optical wedge at a first angle relative to the Tx chief ray axis; refracting, by the optical wedge, a BPLO beam from the optical wedge at a second angle relative to the Tx chief ray axis, the second angle being different from the first angle; and receiving, at a system lens, the Tx beam and the BPLO beam according to a symmetric beam footprint on the system lens.

Example 2 may be combined with Example 1 and includes that the surface of the optical wedge is an apex surface that is molded at an apex angle, the optical wedge further including an unmolded surface at an opposite side of the optical wedge as the apex surface.

Example 3 may be combined with Example 1 and includes that the surface of the optical wedge is an unmolded surface, the optical wedge further including an apex surface molded at an apex angle at an opposite side of the optical wedge as the unmolded surface.

Example 4 may be combined with any of Examples 1-3 and includes that the optical wedge is tilted from a perpendicular angle relative to the Tx chief ray axis.

Example 5 may be combined with any of Examples 1˜4 and includes that the optical wedge is included in an array of optical wedges comprising at least a second optical wedge, the method further including: transmitting, along a second Tx chief ray axis, a second Tx beam that, in either order, passes through a second source lens and contacts a second surface of the at least the second optical wedge, the second source lens being centered about the second Tx chief ray axis.

Example 6 may be combined with any of Examples 1-5 and includes that the array of optical wedges directs the Tx beam and the second Tx beam from the array of optical wedges at a same first angle as the first angle, and wherein the array of optical wedges refracts the BPLO beam and a second BPLO beam from the array of optical wedges at a same second angle as the second angle, the second BPLO beam being refracted from the second optical wedge.

Example 7 may be combined with any of Examples 1-6 and includes that the Tx beam and the BPLO beam are symmetric on the system lens relative to the second Tx beam and the second BPLO beam.

Example 8 may be combined with any of Examples 1-7 and includes that the symmetric beam footprint on the system lens is symmetric about an optical axis of the LiDAR system, the system lens being centered about the optical axis, the optical axis being parallel to the Tx chief ray axis.

Example 9 may be combined with any of Examples 1-8 and includes that the Tx beam and the BPLO beam converge toward a target plane.

Example 10 is a method of using an array of optical wedges in a LiDAR system, including: transmitting, along respective Tx chief ray axes, a plurality of Tx beams including a first Tx beam and a second Tx beam, the plurality of Tx beams being, in either order, passed through an array of source lens and contacting the array of optical wedges, each source lens in the array of source lenses being centered about the respective Tx chief ray axes; directing, by the array optical wedges, the first Tx beam and the second Tx beam at a same first angle from an LO window; refracting, by the array of optical wedges, a plurality of BPLO beams including a first BPLO beam and a second BPLO beam, the plurality of BPLO beams being refracted at a same second angle from the LO window; and receiving, at a system lens, the plurality of Tx beams and the plurality of BPLO beams according to a symmetric beam footprint on the system lens.

Example 11 may be combined with Example 10 and includes that the array of optical wedges includes an apex surface profile molded according to an apex angle and an unmolded surface profile on an opposite side of the array of optical wedges as the apex surface profile.

Example 12 may be combined with any of Examples 10-11 and includes that the array of optical wedges is tilted from a perpendicular angle relative to the respective Tx chief ray axes.

Example 13 is a method of using an optical wedge in a LiDAR system, including: transmitting, along a Tx chief ray axis, a Tx beam that passes through a source lens and contacts an apex surface of the optical wedge, the source lens being centered about the Tx chief ray axis; directing by the optical wedge, towards a system lens, the Tx beam at a first angle relative to the Tx chief ray axis; refracting by the optical wedge, towards the system lens, a BPLO beam at a second angle relative to the Tx chief ray axis, the second angle being a mirror opposite angle about the Tx chief ray axis as the first angle; and receiving, at the system lens, the Tx beam and the BPLO beam according to a symmetric beam footprint on the system lens.

Example 14 is a LiDAR system for implementing a method as in any of Examples 1-13.

Example 15 is an apparatus for implementing a method as in any of Examples 1-13.

Example 16 is a LiDAR system including means for implementing a method as in any of Examples 1-13.

Example 17 is a non-transitory computer-readable medium storing computer executable code, the code when executed by a processor causes the processor to implement a method as in any of Examples 1-13.

What is claimed is:

1. A method of using an optical wedge in a light detection and ranging (LiDAR) system, comprising:
transmitting, along a transmit (Tx) chief ray axis, a Tx beam that, in either order, passes through a source lens and contacts a surface of the optical wedge, the source lens being centered about the Tx chief ray axis;
directing, by the optical wedge, the Tx beam from the optical wedge at a first angle relative to the Tx chief ray axis;
refracting, by the optical wedge, a back projected local oscillator (BPLO) beam from the optical wedge at a second angle relative to the Tx chief ray axis, the second angle being different from the first angle; and
receiving, at a system lens, the Tx beam and the BPLO beam according to a symmetric beam footprint on the system lens.

2. The method of claim 1, wherein the surface of the optical wedge is an apex surface that is molded at an apex angle, the optical wedge further including an unmolded surface at an opposite side of the optical wedge as the apex surface.

3. The method of claim 1, wherein the surface of the optical wedge is an unmolded surface, the optical wedge further including an apex surface molded at an apex angle at an opposite side of the optical wedge as the unmolded surface.

4. The method of claim 1, wherein the optical wedge is tilted from a perpendicular angle relative to the Tx chief ray axis.

5. The method of claim 1, wherein the optical wedge is included in an array of optical wedges comprising at least a second optical wedge, the method further comprising:
transmitting, along a second Tx chief ray axis, a second Tx beam that, in either order, passes through a second source lens and contacts a second surface of the at least the second optical wedge, the second source lens being centered about the second Tx chief ray axis.

6. The method of claim 5, wherein the array of optical wedges directs the Tx beam and the second Tx beam from the array of optical wedges at a same first angle as the first angle, and wherein the array of optical wedges refracts the BPLO beam and a second BPLO beam from the array of optical wedges at a same second angle as the second angle, the second BPLO beam being refracted from the second optical wedge.

7. The method of claim 6, wherein the Tx beam and the BPLO beam are symmetric on the system lens relative to the second Tx beam and the second BPLO beam.

8. The method of claim 1, wherein the symmetric beam footprint on the system lens is symmetric about an optical axis of the LiDAR system, the system lens being centered about the optical axis, the optical axis being parallel to the Tx chief ray axis.

9. The method of claim 1, wherein the Tx beam and the BPLO beam converge toward a target plane.

10. A light detection and ranging (LiDAR) system including an optical wedge, the LiDAR system configured to:
transmit, along a transmit (Tx) chief ray axis, a Tx beam that, in either order, passes through a source lens and contacts a surface of the optical wedge, the source lens being centered about the Tx chief ray axis;
direct by the optical wedge, the Tx beam from the optical wedge at a first angle relative to the Tx chief ray axis;
refract, by the optical wedge, a back projected local oscillator (BPLO) beam from the optical wedge at a second angle relative to the Tx chief ray axis, the second angle being different from the first angle; and
receive, at a system lens, the Tx beam and the BPLO beam according to a symmetric beam footprint on the system lens.

11. The LiDAR system of claim 10, wherein the surface of the optical wedge is an apex surface that is molded at an apex angle, the optical wedge further including an unmolded surface at an opposite side of the optical wedge as the apex surface.

12. The LiDAR system of claim 10, wherein the surface of the optical wedge is an unmolded surface, the optical wedge further including an apex surface molded at an apex angle at an opposite side of the optical wedge as the unmolded surface.

13. The LiDAR system of claim 10, wherein the optical wedge is tilted from a perpendicular angle relative to the Tx chief ray axis.

14. The LiDAR system of claim 10, wherein the optical wedge is included in an array of optical wedges comprising at least a second optical wedge, the LiDAR system further configured to:
transmit, along a second Tx chief ray axis, a second Tx beam that, in either order, passes through a second source lens and contacts a second surface of the at least the second optical wedge, the second source lens being centered about the second Tx chief ray axis.

15. The LiDAR system of claim 14, wherein the array of optical wedges directs the Tx beam and the second Tx beam from the array of optical wedges at a same first angle as the first angle, and wherein the array of optical wedges refracts the BPLO beam and a second BPLO beam from the array of optical wedges at a same second angle as the second angle, the second BPLO beam being refracted from the second optical wedge.

16. The LiDAR system of claim 15, wherein the Tx beam and the BPLO beam are symmetric on the system lens relative to the second Tx beam and the second BPLO beam.

17. The LiDAR system of claim 10, wherein the symmetric beam footprint on the system lens is symmetric about an optical axis of the LiDAR system, the system lens being centered about the optical axis, the optical axis being parallel to the Tx chief ray axis.

18. A light detection and ranging (LiDAR) system including an array of optical wedges, the LiDAR system configured to:
transmit, along respective transmit (Tx) chief ray axes, a plurality of Tx beams including a first Tx beam and a second Tx beam, the plurality of Tx beams being, in either order, passed through an array of source lens and contacted to the array of optical wedges, each source lens in the array of source lenses being centered about the respective Tx chief ray axes;
direct, by the array optical wedges, the first Tx beam and the second Tx beam at a same first angle from a local oscillator (LO) window;
refract, by the array of optical wedges, a plurality of back projected local oscillator (BPLO) beams including a first BPLO beam and a second BPLO beam, the plurality of BPLO beams being refracted at a same second angle from the LO window; and
receive, at a system lens, the plurality of Tx beams and the plurality of BPLO beams according to a symmetric beam footprint on the system lens.

19. The LiDAR system of claim 18, wherein the array of optical wedges includes an apex surface profile molded according to an apex angle and an unmolded surface profile on an opposite side of the array of optical wedges as the apex surface profile.

20. The LiDAR system of claim 18, wherein the array of optical wedges is tilted from a perpendicular angle relative to the respective Tx chief ray axes.
